(19) United States
(12) Patent Application Publication
(10) Pub. No.: US 2022/0315359 A1
(43) Pub. Date: Oct. 6, 2022

(54) Nesting Cuttings Box System

(71) Applicant: Anthony Bellina, Houma, LA (US)

(72) Inventor: Anthony Bellina, Covington, LA (US)

(21) Appl. No.: 17/721,036

(22) Filed: Apr. 14, 2022

Related U.S. Application Data
(63) Continuation of application No. 17/166,866, filed on Feb. 3, 2021, now abandoned.

(51) Int. Cl. B65G 59/10; B65G 59/06; B65D 21/02

(52) U.S. Cl. CPC B65G 59/10; B65G 59/061; B65D 21/0233; E21B 21/065

(57) ABSTRACT

The disclosure relates to a storage device system configured to carry cuttings from an offshore oil drilling rig to a vessel and then to shore for disposal. The system includes a set of nested boxes and lids designed to contain solids as well as some hydrocarbons. The ability to nest the boxes and lids leads to considerable reduction in space requirements relative to conventional systems. For example, according to an embodiment, each box is configured to only take up an additional 12″ in height for each nested box. As such, five nested boxes and lids only occupy a height equivalent to two stacked conventional boxes. Each box and lid is configured to serve as a closed container having hatches for filling the container with cuttings. The container is configured to withstanding pressures up to 5 psi while preventing fumes from escaping. Embodiments may have greater or fewer than five boxes.

### STATEMENT OF RELATED CASES

The instant application claims the benefit or prior U.S. provisional application No. 62/969,422 filed Feb. 3, 2020; U.S. provisional application No. 62/977,811 filed Feb. 18, 2020; U.S. provisional application No. 63/002,723 filed Mar. 31, 2020; and U.S. provisional application No. 62/976,676 filed Feb. 14, 2020, the entireties of which are incorporated herein by reference.

### BRIEF DESCRIPTION OF THE DRAWINGS

The accompanying drawings form a part of this disclosure and are incorporated into the specification. The drawings illustrate example embodiments of the disclosure and, in conjunction with the description and claims, serve to explain various principles, features, or aspects of the disclosure. Certain embodiments of the disclosure are described more fully below with reference to the accompanying drawings. However, various aspects of the disclosure are implemented in many different forms and should not be construed as being limited to the implementations set forth herein.

FIG. 1A illustrates a side view of five nested boxes and five nested lids, according to an embodiment.

FIG. 1B illustrates three-dimensional top perspective view of a system including five nested boxes and five nested lids, according to an embodiment.

FIG. 2 illustrates a side view of five nested boxes and five nested lids, the lids moved into place via a sling, according to an embodiment.

FIG. 3 illustrates a side view of five nested boxes and five nested lids in which a pin coupling the sling to a first box is removed, according to an embodiment.

FIG. 4 illustrates a side view of five nested boxes and five nested lids in which the pin is moved from a first box to a second box, according to an embodiment.

FIG. 5 illustrates a side view of five nested boxes and five nested lids in which the pin is re-engaged with the sling, thereby coupling the sling to the second box, according to an embodiment.

FIG. 6 illustrates a configuration in which a first box is decoupled from the remaining nested boxes and lids, according to an embodiment.

FIG. 7 illustrates a configuration in which the remaining nested boxes and lids is moved away from the decoupled box shown in FIG. 6, according to an embodiment.

FIG. 8 illustrates a configuration in which the sling is decoupled from the second box and coupled to the first lid, according to an embodiment.

FIG. 9 illustrates a configuration in which the sling has lifted the first lid away from the remaining nested boxes and lids, according to an embodiment.

FIG. 10 illustrates a configuration in which the first lid is placed on the first box, according to an embodiment.

FIG. 11 illustrates a configuration in which a lid is installed on a box, according to an embodiment.

FIG. 12 illustrates a further example configuration to which a set of lids is fixed to a set of five nested boxes, according to an embodiment.

FIG. 13 illustrates a still further example embodiment, in which the sides of the box are depicted as inwardly tapered downward such that the bottommost portion of the box has a lesser outer diameter than the topmost portion of the box so that balance is better maintained during installation and transportation and space is provided for a fastener to connect the box to an associated lifting mechanism, according to an embodiment.

FIG. 14 illustrates a nested set of boxes and lids as coupled with an associated lifting mechanism disposed in mechanical communication with a plurality of connective fasteners.

### DETAILED DESCRIPTION OF SEVERAL EXAMPLE EMBODIMENTS

The instant disclosure relates to a storage device system configured to carry cuttings from an offshore oil drilling rig to a vessel and then to shore for disposal. The system comprises a set of boxes and lids designed to contain solids as well as some hydrocarbons. The boxes and lids are configured to be nested, primarily for ease of handling and in order to save space. In particular, the ability to nest the boxes and lids achieves more efficient transportation and installation, and a considerable reduction in space requirements relative to conventional systems. For example, according to an embodiment, once nested (i.e., partially placed down inside of the interior volume of the box beneath it), each box is configured to take up only an additional 12″ in height for each nested box. As such, five nested boxes and lids only occupy the height equivalent of two stacked conventional boxes. The stacked boxes and lids are very heavy though, so that an individual box and lid set integrated in such fashion can weigh around five-thousand pounds or more. In one example embodiment, a box portion weighs between 3,500 and 5,000 pounds, and in a particular though limiting embodiment between 3,750 and 4,250 pounds. In another example, a lid portion weighs between 1,500 and 2,000 pounds, and in a particular though non-limiting embodiment between 1,600 and 1,800 pounds. In other embodiments, lid thicknesses can also vary. In one example embodiment, the lid measures between 0.5 and 1.5 inches, and in a particular though non-limiting embodiment, the lid measures between 0.75 and 1.25 inches. Due to safety laws and regulations, the boxes and lids, whether considered alone or in combination, are therefore far too heavy and bulky to allow them to be moved and set up by sheer manpower; instead, a lifting and separating system must be implemented that achieves safe, predictable handling, separation and set up.

In one example embodiment, each box and lid pair is configured as a closed container system having hatches for filling the container with cuttings. In another embodiment, the container is configured to withstand pressures up to around 5 psi or so, while preventing fumes from escaping as fugitive emissions. In one example embodiment, the embodiments disclosed herein are used on offshore rigs and supply vessels to conserve deck space when boxes are empty. In a further embodiment described in detail below, nested boxes and lids are lifted together using a sling. In a still further embodiment, a set of five boxes and paired lids provides storage capacity of around 25 barrels each. In a further embodiment still, disclosed boxes and lids conform to the known standards associated with conventional boxes. In certain embodiments, disclosed designs satisfy the requirements for approval by DNV-GL to meet Standard DNVGL-ST-E271-2.7-1, Offshore Containers, August 2017, as well as DOT 49 C.F.R. § 176.340 for combustible liquids. An estimated tare weight for five empty nested boxes with lids and rigging is around 25,000 lbs. Ordinarily skilled artisans will readily recognize that other embodiments may include greater or fewer nested boxes and nested lids, have different dimensions meeting alternative or customized standards, and weigh more or less than the example embodiments described herein.

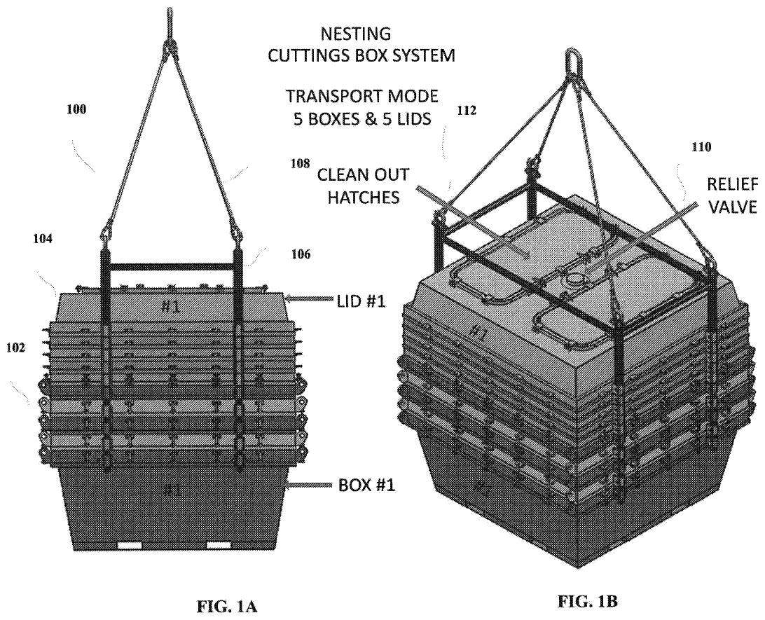

FIG. 1A illustrates a side view of a system 100 including five nested boxes 102 and five nested lids 104, according to an embodiment. A sling 106 is configured to selectively engage one or more boxes and/or one or more lids, as described in detail below. Cables 108 coupled to sling 106 are used to lift the set of nested boxes 102 and nested lids 104. According to one example embodiment, sling 106 is a four-part sling tested to 19,100 lbs. per wire at 45° for a total SWL of 76,400 lbs., using Crosby or Equal G-2130/S-2130 9.5t Bolt-Type shackles. Other embodiments include other design tolerances depending on associated regulatory standards and specific field applications.

FIG. 1B illustrates an example three-dimensional top perspective view of a system 100 comprising five nested boxes 102 and five nested lids 104, according to a further embodiment. As shown, each lid includes a relief valve 110. In one example embodiment, relief valve 110 is configured to withstand pressures up to around 5 psi. In various embodiments, valve 110 is a 10-inch valve configured to allow gases having pressures greater than 5 psi to escape, as be generated upon heating. In some embodiments, the relief valve and lid may be reciprocally machined so that the valve is threaded onto the lid or depressed into a concave machine threading so that the valve head lies as flat as possible relative to the plane of the lid. In further embodiments, each lid further comprises one or more hatches 112 that may be opened for filling a container, and closed when the container is full. In a specific though non-limiting embodiment, each lid is made of marine grade 5086 H111 aluminum in order to reduce weight and increase corrosion resistance. In the further embodiment illustrated in FIG. 1B, each lid further comprises two aluminum 60 inch×27 inch hinged hatches. Those of ordinary skill in the art will readily appreciate that other embodiments comprise other dimensions and characteristics.

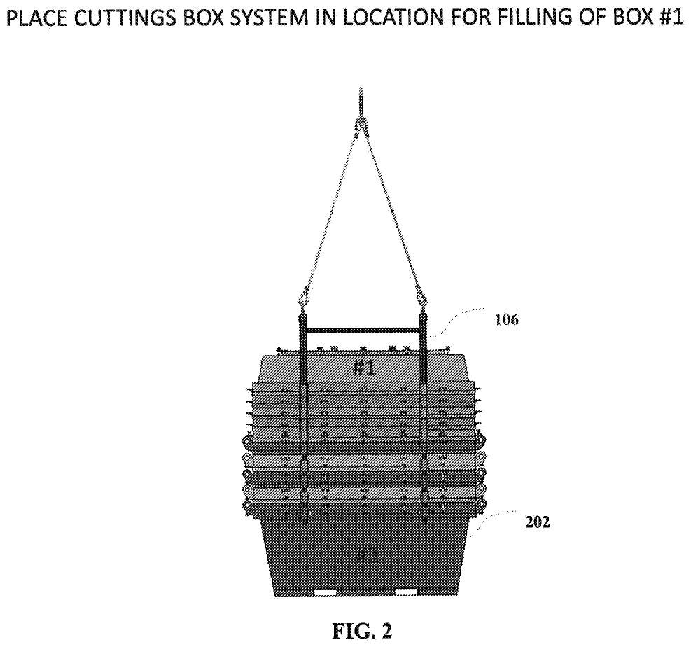

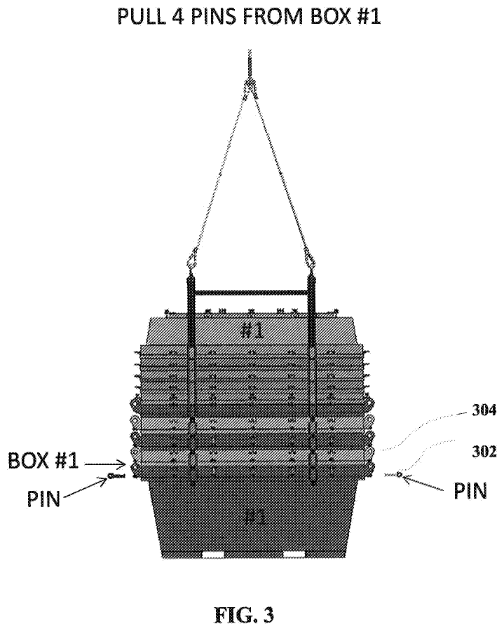

FIG. 2 illustrates a side view of example system 100, comprising five nested boxes 102 and five nested lids 104 that have been moved into place via a sling, according to an embodiment. In this regard, sling 106 is mechanically coupled the first box 202 via pins, as shown in greater detail below with reference to FIG. 3. Because the boxes 102 and lids 104 are nested, coupling of sling 106 to box 202 allows sling 106 to lift the entire set of nested boxes 102 and lids 104. As described below with reference to FIGS. 3 to 5, sling 106 is decoupled from box 202 to allow box 202 to be removed.

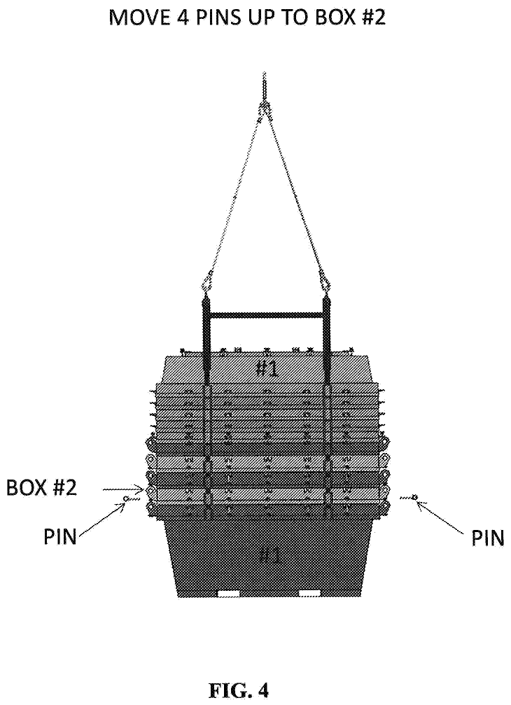

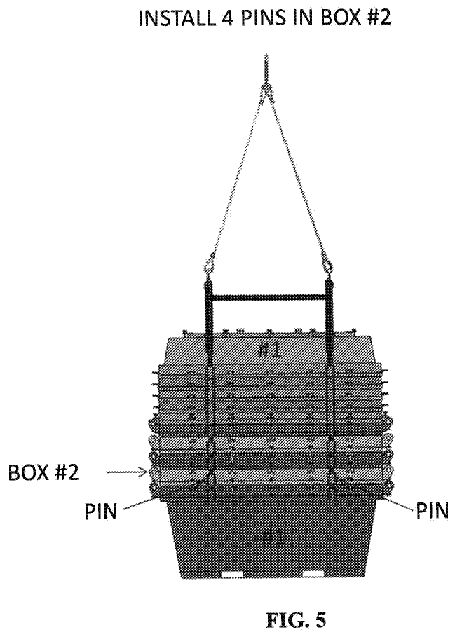

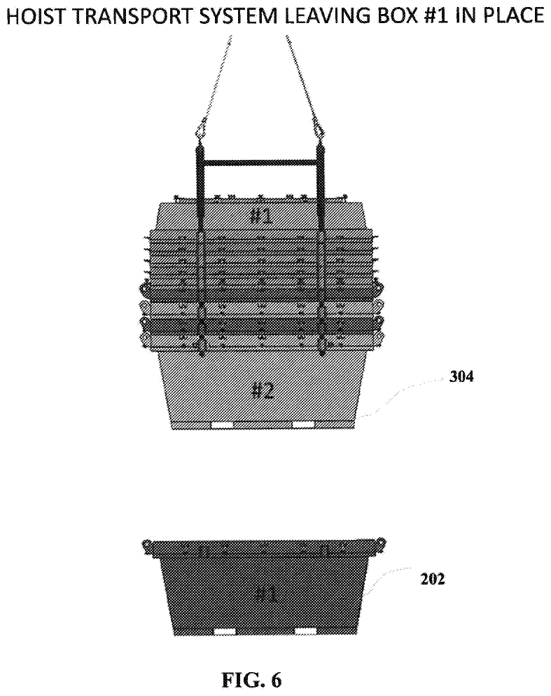

FIGS. 3 to 5 illustrate an example process in which sling 106 is decoupled from box 202, and then coupled with box 304. In this embodiment, in FIG. 3 pins 302 are removed so as to decouple sling 106 from box 202. In the example embodiment of FIG. 4, pin 302 is moved from box 202 to box 304, and in FIG. 5 pin 302 has been re-engaged with sling 106 to thereby couple sling 106 to box 304. In this way, box 202 are left in place while sling 106 lifts the remaining nested boxes and lids, as described below in detail with reference to FIG. 6.

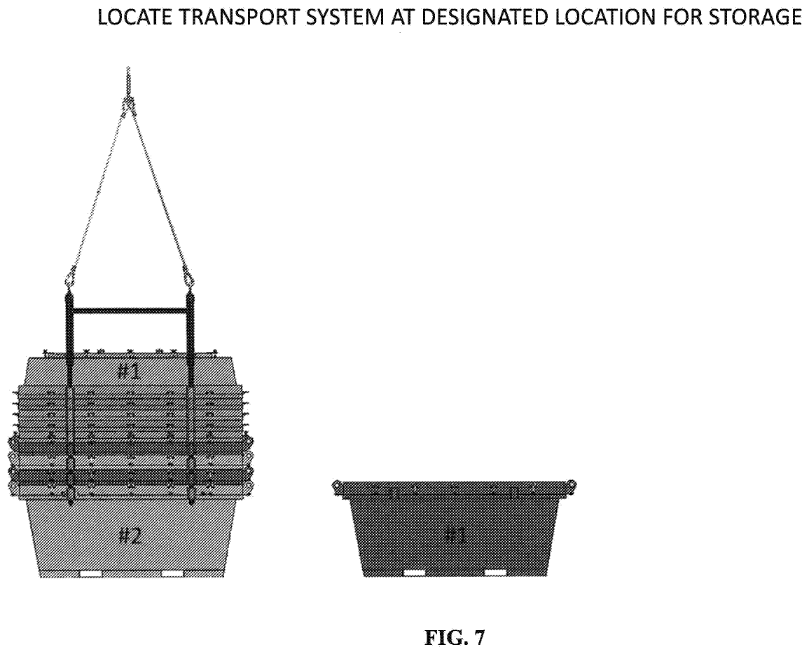

FIGS. 6 to 9 illustrate a further example process in which box 202 is separated from the remaining nested boxes and lids and a lid is installed on box 202. In this regard, FIG. 6 shows sling 106 coupled with box 304 which is the lowermost box in the set of boxes and lids. Box 202 is left in place while the remaining nested boxes and lids are lifted away from box 202. In FIG. 7, the remaining boxes and lids are placed at a location disposed a distance from box 202. In this configuration, pins are removed to decouple sling 106 from box 304.

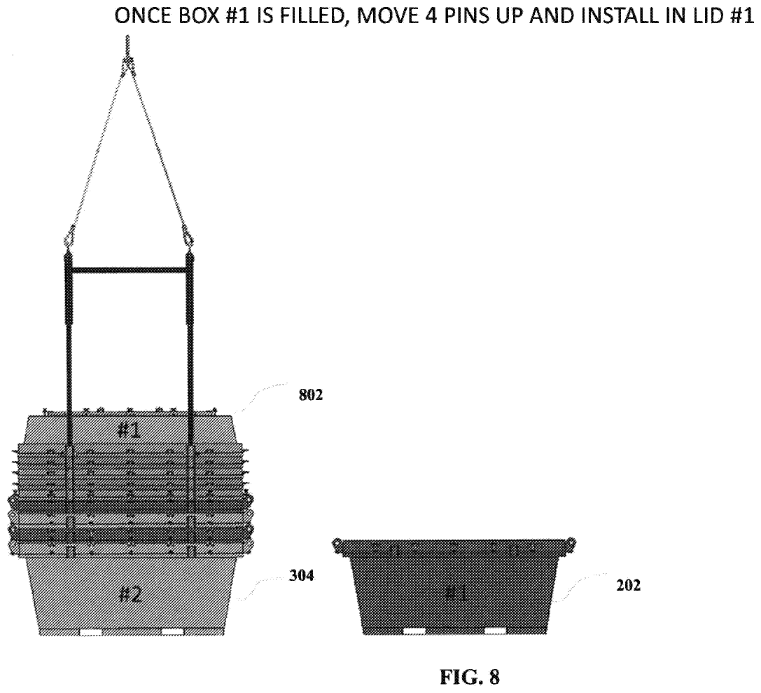

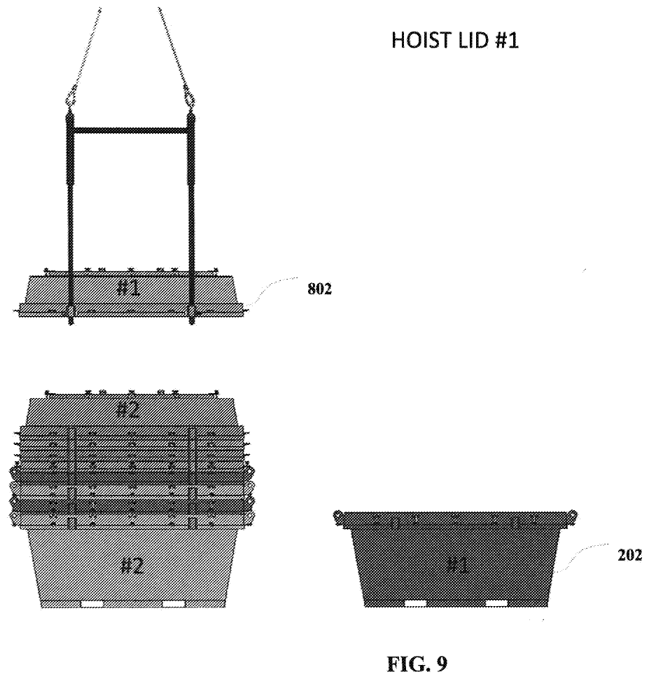

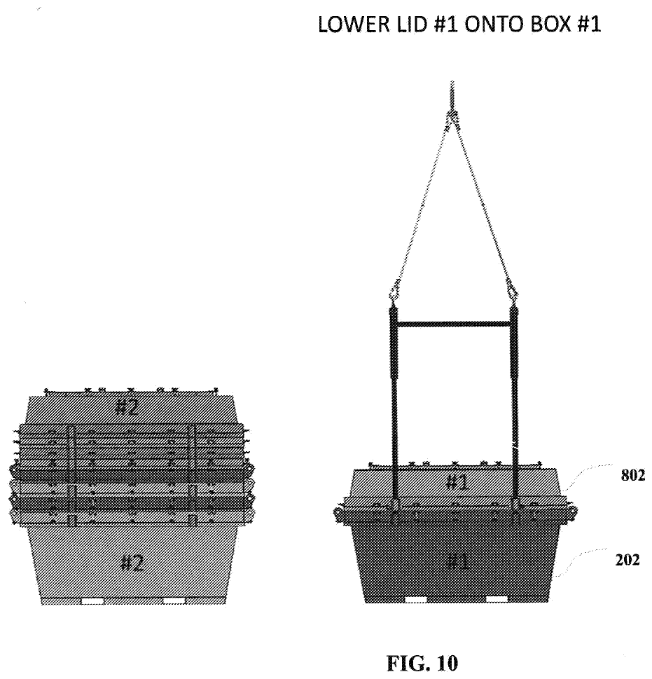

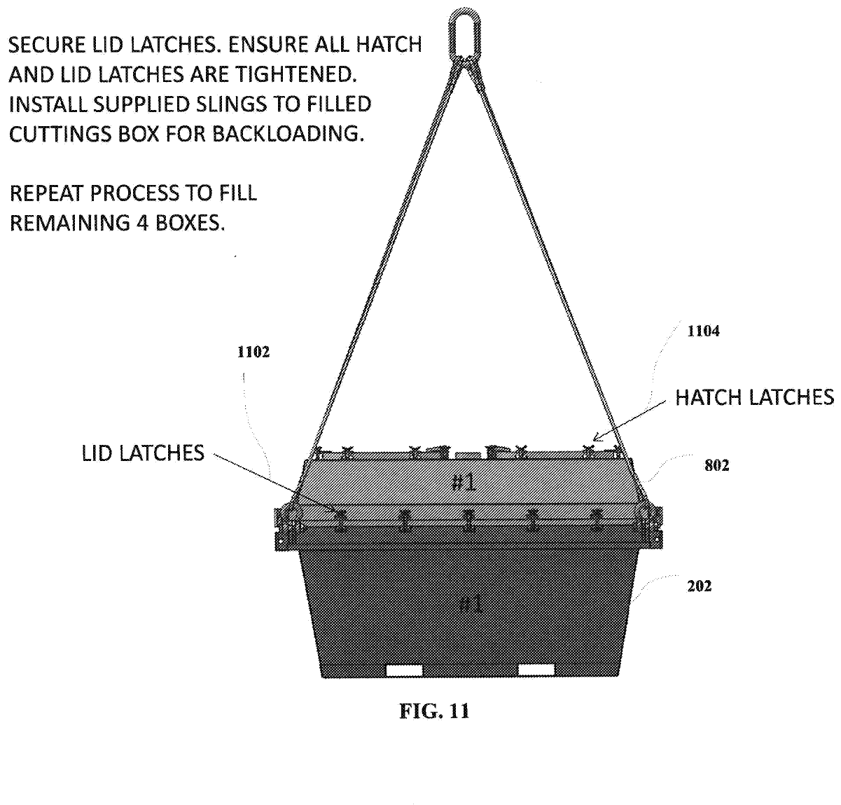

In FIG. 8, the decoupled sling 106 is lifted and pins are re-inserted, thereby coupling sling 106 with lid 802. In FIG. 9, sling 106 has lifted lid 802 away from the remaining nested boxes and lids, and in FIG. 10 lid 802 is placed on top of box 202. FIG. 11 shows a configuration in which lid 802 is secured to box 202 via lid latches 1102. Hatch latches 1104, which may be used to secure lid hatches (e.g., see hatches 112 in FIG. 1B). The system including box 202 with lid 802 secured to box 202 is now be used to receive cuttings as described above.

Still another system and method for individual box separation and lid association is illustrated in FIGS. 12-14. FIG. 12 illustrates a further example configuration to which a set of lids is fixed to a set of five nested boxes. FIG. 13 illustrates a still further example embodiment in which the sides of the box are depicted as inwardly tapered downward such that the bottommost portion of the box has a lesser outer diameter than the topmost portion of the box. In this manner, balance is better maintained during installation and transportation, and space is provided for a fastener to connect the box to an associated lifting mechanism, according to an embodiment. FIG. 14 illustrates a nested set of boxes and lids as coupled with an associated lifting means disposed in mechanical communication with a plurality of connective fasteners.

In the example process, FIG. 12 depicts five nested boxes and a corresponding set of five lids, each of the boxes nesting one inside the next except for the bottommost box, which is disposed flat on the ground. As seen in FIG. 13, room for nesting the boxes is provided by way of inwardly tapering downward the outer side surfaces of each box. A set of fasteners, whether pins, clamps, or other fasteners now know or later devised are disposed to mechanically connect with the lifting mechanism. Once the set has been delivered to an operations site (e.g., a rig), the fasteners are joined with the lifting mechanism (e.g., a lifting sling or any other such means suitable for bearing the combined weight of the box and lift load), and the entire package is hoisted onto a working deck or the like of the rig or operation site as a single package. To separate and distribute the contents of the stack, the lift sling is removed from the bottommost box while the rest of the boxes are removed using the lifting mechanism. In one embodiment, the topmost lid is then placed atop the now isolated bottommost box to form a complete set. The remaining boxes and tops can be removed in like fashion, in each instance the lifting mechanism removing all but the new bottommost box and then fitted with the next topmost lid. One or more such box and lid sets are thereby be formed all at one time, slowly over time as operations needs dictate, or a combination of thereof. In a still further embodiment, the lids are brought aboard separately from the boxes, and then fitted to each box as it is removed from the nested stack. In a presently preferred embodiment, each of the five boxes is removed one at a time by decoupling the fastening pin from the lift cables and then lifting the remaining nested boxes from above so that the bottommost box is exposed and left open on the deck so that a topmost lid are fitted thereupon.

The following tables provide design and material parameters for example embodiments.

Operational Limitations

| Design Parameter | Value | | Equivalent | |
|---|---|---|---|---|
| Rating (maximum) | 13,615 | kg | 30,000 | lbs |
| Payload (maximum) | 11,565 | kg | 25,250 | lbs |
| Tare (maximum) | 986 | kg | 4,750 | lbs |
| Minimum design temperature | 0° | C. | 32° | F. |
| Lifting set WLL (minimum) | 18.26 | t (metric) | | |
| Enhancement factor | 1.34 | | | |
| Number of sling legs | 4 | | | |
| Maximum sling angle from vertical | 45° | | | |
| Shackle size | 9.5 | t (metric) | | |
| Minimum shackle pin diameter | 31.5 | mm | | |
| | 1.24 | in | | |

Maximum External Dimensions

| | | | | |
|---|---|---|---|---|
| Length | 2565 | mm | 101 | in |
| Width | 2565 | mm | 101 | in |
| Height | 986 | mm | 39 | in |

| | | Fibre | Steel | |
|---|---|---|---|---|
| | WLL | core | core | Chain |
| Lifting set requirements | (t) | (mm) | (mm) | (mm) |
| Master link (quad assembly), | 18.26 | 40 | 40 | 25 |
| Forerunner (if applicable) | | | | |
| Shackles and sling leg | 8.61 | 28 | 26 | 18 |
| components | | | | |

Minimum required breaking load (Forerunner) 995 kN
Minimum required breaking load (Sling legs) 469 kN

Material Specifications

Primary Structure Material Specification (Fully
killed as DNVGL-ST-E271 Section 3.1.1.)

| | | Minimum | |
|---|---|---|---|
| | | Yield | |
| Components | Material | Strength | Charpy |
| Open | ASTM | 250 MPa* | 28J @ 10° C. for 6 ≤ t ≤ 12 mm |
| Sections, | A36 | | 28J @ 0° C. for 12 < t ≤ 25 mm |
| Plates | | | 28J @ −20° C. for t > 25 mm |
| Hollow | ASTM | 240 MPa | 27J @ 10° C. for 6 ≤ t ≤ 12mm |
| Section | A53 | | 27J @ 0° C. for 12 < t ≤ 25 mm |
| | | | 27J @ −20° C. for t > 25 mm |

Conditional language, such as, among others, “can,” “could,” “might,” or “may,” unless specifically stated otherwise, or otherwise understood within the context as used, is generally intended to convey that which certain implementations could include, while other embodiments do not include certain features, elements, and/or operations. Thus, such conditional language is not intended to imply that features, elements, and/or operations are in any way required for any particular embodiment, or that any one aspect of the disclosure necessarily informs the logic for deciding, with or without user input or prompting, whether these features, elements, and/or operations are included or are to be performed in any particular embodiment.

While various aspects of the disclosure are described herein with reference to various embodiments, it is noted that such embodiments are illustrative and that the scope of the disclosure is not limited. Those of ordinary skill in the art will readily recognize that many further combinations and permutations of the disclosed features are possible. As such, various modifications can be made to the disclosure without departing from the scope or spirit thereof. In addition or in the alternative, other embodiments of the disclosure will be apparent from consideration of the specification and annexed drawings, and practice of the disclosure as presented herein. The examples put forward in the specification and annexed drawings are illustrative and not restrictive. Although specific terms are employed herein, they are used in a generic and descriptive sense only and not for purposes of limitation.

1. A system, comprising:
a plurality of nested cutting boxes;
a plurality of nested lids; and
a sling,
wherein the sling is configured to be selectively coupled to one or more cutting boxes and/or to one or more lids such that the sling may move all of the cutting boxes and lids together or may move a subset of cutting boxes and/or lids.

2. The system of claim 1, wherein the sling is selectively coupled to the one or more cutting boxes and/or lids using removable pins.

3. A method of installing a plurality of cutting boxes and lids, the method comprising:
using a sling to lift a plurality of nested cutting boxes and lids;
selectively coupling the sling to one or more cutting boxes and/or lids to thereby remove a cutting box and/or a lid from the plurality of nested cutting boxes and lids.

4. The method of claim 3, wherein the sling is selectively coupled to the one or more cutting boxes and/or lids using removable pins.

5. A method of installing a plurality of cutting boxes and lids, the method comprising:
coupling a lift sling to a plurality of fasteners disposed in mechanical communication with a plurality of nested cutting boxes and plurality of lids;
decoupling the lift sling from the fasteners associated with the bottommost box;
using the lift sling to remove the still coupled nested boxes from atop and within the bottommost box, thereby removing said bottommost box from the plurality of nested cutting boxes; and
fitting the topmost lid from the plurality of lids atop a top surface of the removed bottommost box.
